(19) United States
(12) Patent Application Publication
(10) Pub. No.: US 2015/0281856 A1
(43) Pub. Date: Oct. 1, 2015

(54) METHOD FOR ADAPTING SOUND OF HEARING AID AND HEARING AID AND ELECTRONIC DEVICE PERFORMING THE SAME

(71) Applicant: Samsung Electronics Co., Ltd., Gyeonggi-do (KR)

(72) Inventors: Sun Jin Park, Gyeonggi-do (KR); Seung Young Jeon, Gyeonggi-do (KR)

(21) Appl. No.: 14/668,468

(22) Filed: Mar. 25, 2015

(30) Foreign Application Priority Data
Mar. 25, 2014 (KR) 10-2014-0034707

(51) Int. Cl. H04R 25/00

(52) U.S. Cl. CPC H04R 25/50

(57) ABSTRACT

Provided are a method for modulating sound at a hearing aid and a hearing aid performing the method. The method includes acquiring a sound signal at the hearing aid, modulating the at least a portion of the sound signal when the at least a portion of the sound signal is similar to the designated attention word data, and outputting the modulated sound signal.

### CROSS-REFERENCE TO RELATED APPLICATION(S) AND CLAIM OF PRIORITY

The present application is related to and claims priority under 35 U.S.C. §119(a) to a Korean Patent Application filed on Mar. 25, 2014 in the Korean Intellectual Property Office and assigned Serial No. 10-2014-0034707, the entire contents of which are incorporated herein by reference.

### TECHNICAL FIELD

The present disclosure relates to hearing aids.

### BACKGROUND

For the past years, the population being hearing-impaired may have increased due to the use of audio equipment, an increase in aging population, and an increase in noise environment. As demand for hearing aids increases according to an increase in the population being hearing-impaired, there hearing aids having various functions have been developed.

In particular, with the development of a digital hearing aid technology, there is an increase in hearing aids capable of being optimized to be suitable for a hearing characteristic of a hearing aid user.

### SUMMARY

To address the above-discussed deficiencies, it is a primary object to provide a method for modulating sound of a hearing aid and a hearing aid and an electronic device performing the same. Also, another embodiment of the present disclosure provides computer-readable storage media storing a program for allowing the method to be executed on a computer.

However, technical problems to be solved through various embodiments of the present disclosure may not be limited to the above-described technical problems, and other technical problems may be present and solved through the various embodiments of the present disclosure.

In accordance with the present disclosure, a method for modulating sound at a hearing aid is provided. The method includes acquiring a sound signal at the hearing aid; comparing at least a portion of the sound signal with designated attention word data; modulating the at least a portion of the sound signal when the comparison result indicates that the at least a portion of the sound signal is similar to the designated attention word data; and outputting the modulated sound signal.

In accordance the present disclosure, a computer-readable storage media which stores a program for executing a method of modulating sound at a hearing aid is provided.

In accordance the present disclosure, a hearing aid which includes a storage unit, a sound detecting module, a control module, and a sound outputting module is provided. The storage stores designated attention word data. The sound detecting module acquires a sound signal. The control module compares at least a portion of the sound signal with the designated attention word data and to modulate at least a portion of the sound signal when the at least a portion of the sound signal is determined as being similar to the designated attention word data. The sound outputting module outputs the modulated sound signal.

In accordance with the present disclosure, an electronic device which includes a storage, a communication interface module, and a processor is provided. The storage stores attention word database. The communication interface module communicates with a hearing aid functionally connected with the electronic device. The processor sets an attention word of the attention word database to the hearing aid using a hearing aid program.

As described above, various embodiments allow a user to hear, from sound detected by a hearing aid, some words which interest the user, and some words requiring the user's attention, thereby improving user's convenience.

Various embodiments allow a user to clearly perceive some words in a loud environment in which many people speak simultaneously, thereby making it possible to identify a conversation partner easily and for a user to have a sense of security, psychologically.

Also, various embodiments allow some words requiring user's attention to be emphasized and output, thereby preventing a dangerous situation in advance.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a hearing aid according to various embodiments of the present disclosure;

FIG. 2 illustrates a block diagram of an electronic device according to various embodiments of the present disclosure;

FIG. 3 illustrates a diagram of an environment for setting an attention word to a hearing aid according to various embodiments of the present disclosure;

FIG. 4 illustrates an environment for setting an attention word to a hearing aid according to various embodiments of the present disclosure;

FIG. 5 illustrates an environment for setting an attention word to a hearing aid according to various embodiments of the present disclosure;

FIG. 6 illustrates a screen for notifying a danger at an electronic device operating in conjunction with a hearing aid according to various embodiments of the present disclosure; and

FIG. 7 illustrates a method for modulating sound of a hearing aid according to various embodiments of the present disclosure.

### DETAILED DESCRIPTION

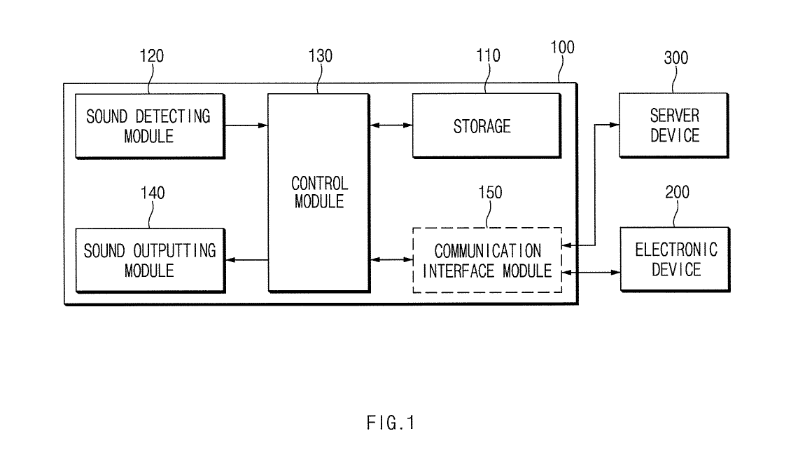

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. Hereinafter, the present disclosure is described with reference to the accompanying drawings. Various modifications are possible in various embodiments of the present disclosure and embodiments are illustrated in drawings and related detailed descriptions are listed. Thus, it is intended that the present disclosure covers modifications and variations of embodiments of this disclosure, provided they come within the scope of the appended claims and their equivalents. With respect to the descriptions of the drawings, like reference numerals refer to like elements.

The terms “include,” “comprise,” and “have”, or “may include,” or “may comprise” and “may have” used herein indicate disclosed functions, operations, or existence of elements but does not exclude other functions, operations or elements. Additionally, in this specification, the meaning of “include,” “comprise,” “including,” or “comprising,” specifies a property, a region, a fixed number, a step, a process, an element and/or a component but does not exclude other properties, regions, fixed numbers, steps, processes, elements and/or components.

The meaning of the term “or” used herein includes any or all combinations of the words connected by the term “or”. For instance, the expression “A or B” may indicate include A, B, or both A and B. As used herein, the term “and/or” includes any and all combinations of one or more of the associated listed items.

The terms such as “1st”, “2nd”, “first”, “second”, and the like used herein may refer to modifying various different elements of various embodiments, but do not limit the elements. For instance, such terms do not limit the order and/or priority of the elements. Furthermore, such terms may be used to distinguish one element from another element. For instance, both “a first user device” and “a second user device” indicate a user device but indicate different user devices from each other. For example, a first component may be referred to as a second component and vice versa without departing from the scope of the present disclosure.

In the description below, when one part (or element, device, etc.) is referred to as being “connected” to another part (or element, device, etc.), it should be understood that the former can be “directly connected” to the latter, or “electrically connected” to the latter via an intervening part (or element, device, etc.). It will be further understood that when one component is referred to as being “directly connected” or “directly linked” to another component, it means that no intervening component is present.

Terms used in this specification are used to describe embodiments of the present disclosure and are not intended to limit the scope of the present disclosure. The terms of a singular form may include plural fauns unless otherwise specified.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

An electronic device according to various embodiments of the present disclosure may have a communication function. For instance, electronic devices may include at least one of smartphones, tablet Personal Computers (PCs), mobile phones, video phones, electronic book (e-book) readers, desktop PCs, laptop PCs, netbook computers, Personal Digital Assistants (PDAs), Portable Multimedia Players (PMPs), Moving Picture Experts Group Audio Layer 3 (MP3) players, mobile medical devices, cameras, and wearable devices (e.g., Head-Mounted-Devices (HMDs) such as electronic glasses, electronic apparel, electronic bracelets, electronic necklaces, electronic accessories, electronic tattoos, and smart watches).

According to some embodiments of the present disclosure, an electronic device may be smart home appliances having a communication function. The smart home appliances may include at least one of, for example, televisions, Digital Video Disk (DVD) players, audio devices, refrigerators, air conditioners, cleaners, ovens, microwave ovens, washing machines, air cleaners, set-top boxes, TV boxes (e.g., Samsung HomeSync™, Apple TV™ or Google TV™), game consoles, electronic dictionaries, electronic keys, camcorders, and electronic picture frames.

According to embodiments of the present disclosure, an electronic device may include at least one of various medical devices (for example, Magnetic Resonance Angiography (MRA) devices, Magnetic Resonance Imaging (MRI) devices, Computed Tomography (CT) devices, medical imaging devices, ultrasonic devices, etc.), navigation devices, Global Positioning System (GPS) receivers, Event Data Recorders (EDRs), Flight Data Recorders (FDRs), vehicle infotainment devices, marine electronic equipment (for example, marine navigation systems, gyro compasses, etc.), avionics, security equipment, car head units, industrial or household robots, financial institutions' Automated Teller Machines (ATMs), and stores' Point Of Sale (POS) systems.

According to an embodiment of the present disclosure, an electronic device may include at least one of furniture or buildings/structures having a communication function, electronic boards, electronic signature receiving devices, projectors, or various measuring instruments (for example, water, electricity, gas, or radio signal measuring instruments). An electronic device according to an embodiment of the present disclosure may be one of the above-mentioned various devices or a combination thereof Additionally, an electronic device according to an embodiment of the present disclosure may be a flexible device. Furthermore, it is apparent to those skilled in the art that an electronic device according to an embodiment of the present disclosure is not limited to the above-mentioned devices.

Hereinafter, an electronic device according to various embodiments of the present disclosure will be described in more detail with reference to the accompanying drawings. The term “user” in various embodiments may refer to a person using an electronic device or a device using an electronic device (for example, an artificial intelligent electronic device).

FIG. 1 illustrates a block diagram of a hearing aid according to various embodiments of the present disclosure.

Referring to FIG. 1, a hearing aid 100 may contain a storage unit 110, a sound detecting module 120, a control module 130, and a sound outputting module 140. According to various embodiments, the hearing aid 100 may further include a communication interface module 150.

In this specification, components related to this embodiment may be only described to prevent features of this embodiment from becoming ambiguous. Accordingly, it will be apparent to one skilled in the art that other universal components as well as components shown in FIG. 1 are further included in the hearing aid 100.

The hearing aid 100 may perform a signal process (e.g., amplification) for sound detected through the sound detecting module 120 such that a user hears hearing loss compensated sound. The hearing aid 100 according to this embodiment may adjust a sound signal, corresponding to an attention word, from among the detected sound of the hearing aid 100, thereby improving user's perception on the attention word.

The storage 110 may store attention word data corresponding to an attention word. The attention word may indicate a word requiring user's attention. The attention word may include a word related to a dangerous situation or a user name. The attention word may be put in the hearing aid 100 through a program (hereinafter referred to as “hearing aid program”) related to the hearing aid 100.

The attention word data may be a combination of at least one voice acoustic waveform constituting the attention word. The attention word data may be generated by dividing the attention word into phonemes of consonants and vowels and combing voice acoustic waveforms of the phonemes. For example, the attention word data may be acoustic data.

The sound detecting module 120 may detect surrounding sound of the hearing aid 100 and may obtain a sound signal by converting the detected sound into an electric signal. The sound detecting module 120 may send the sound signal to the control module 130.

According to this embodiment, the sound detecting module 120 may be implemented with a microphone and so on. According to this embodiment, the sound detecting module 120 may further include an analog-to-digital converter (not shown). The analog-to-digital converter may convert an analog signal acquired from the sound detecting module 120 into a digital signal. The control module 130 may process the digital signal using a Digital Signal Processor (DSP).

The control module 130 may process the sound signal. The control module 130 may adjust an output level, a frequency, and so on of the sound signal.

In this embodiment, the control module 130 may compare a designated attention word data with at least a portion of the sound signal. The control module 130 may modulate the sound signal corresponding to the attention word when the comparison result indicates that at least a portion of the sound signal is similar to the attention word data.

In comparing the attention word data and the sound signal, according to certain embodiments, the control module 130 may compare at least a portion of the sound signal with the attention word data by the frame. The control module 130 may calculate a score based on coherence between the sound signal and the attention word data determined every frame. When the calculated score is greater than or equal to a reference score, the control module 130 may determine the sound signal as being an attention word.

Also, the control module 130 may compare the sound signal and the attention word data using techniques such as DTW (Dynamic Time Warping), HMM (Hidden Markov Modeling), Neural Network, and so on. Such techniques may be well known, and a detailed description thereof is thus omitted.

Besides, it will be apparent to one skilled in the art that the control module 130 can utilize other various techniques to compare a sound signal and attention word data.

The control module 130 may modulate a sound signal by increasing an output level of the sound signal corresponding to the attention word or shifting a frequency band corresponding thereto.

According to certain embodiments, the control module 130 may set an output level of a sound signal corresponding to an attention word to be higher than that of any other sound, thereby allowing a user to recognize the attention word more greatly than any other sound.

According to another embodiment, the control module 130 may shift a frequency band of a sound signal corresponding to an attention word into an optimum frequency band. The optimum frequency band may be a frequency band in which a user recognizes a sound better. As the frequency band is shifted into the optimum frequency band, the user may recognize an attention word better than any other sound. For example, the optimum frequency band may be a band of 3,000 to 4,000 Hz in which a human ear can recognize best. Alternatively, the optimum frequency band may be a frequency band that is determined according to a hearing characteristic of a user. The hearing characteristic of the user may be information related to the user's hearing indicating that the user hears sound of any frequency band to what extent.

Furthermore, the control module 130 may apply both an increase in an output level and a shift of a frequency band to a sound signal to adjust the sound signal.

Besides, the control module 130 may adjust a sound signal corresponding to an attention word by performing a signal process such that the sound signal is distinguishable from any other sound signal.

According to certain embodiments, the control module 130 may distinguish an attention word related to a dangerous situation from any other attention word. When a sound signal corresponds to an attention word related to a dangerous situation, the control module 130 may send the attention word related to the dangerous situation to an electronic device 200 that is functionally connected with the hearing aid 100. This is to inform a user of a danger-related attention word through the electronic device 200 if the hearing aid 100 and the electronic device 200 connected with the hearing aid 100 all exist.

According to certain embodiments, the control module 130 may modulate sound related to a dangerous situation as well as an attention word such that a user of the hearing aid 100 hears the sound related to the dangerous situation better than any other sound. For this, the control module 130 may compare a sound signal with attention word data on sound, which is stored at the hearing aid 100 and is related to a dangerous situation. The control module 130 may adjust a relevant sound signal when the sound signal corresponds to a sound associated with a dangerous situation.

Also, the control module 130 may perform a signal process to modulate an output level and so on by the channel. For example, the control module 130 may process various types of digital signals using a digital signal processor. Accordingly, besides the above-described signal process, the control module 130 can perform complicated signal processes such as noise rejection, acoustic feedback rejection, and so on.

The sound outputting module 140 may amplify sound detected from the sound detecting module 120, according to an output level determined by the control module 130. The sound outputting module 140 may modulate a sound signal corresponding to an attention word such that a user recognizes it better than any other sound signal.

According to certain embodiments, the sound outputting module 140 may be implemented with a speaker, a receiver, and so on. According to certain embodiments, the sound outputting module 140 may further include a digital-to-analog converter (not shown). The digital-to-analog converter may convert a digital signal received from the sound outputting module 140 into an analog signal and may output the analog signal.

According to certain embodiments, the hearing aid 100 may further include the communication interface module 150. The electronic device 200 may fit the hearing aid 100 using the hearing aid program. For this, the hearing aid 100 may be connected with the electronic device 200 through the communication interface module 150. Furthermore, according to this embodiment, the communication interface module 150 may send an attention word related to a dangerous situation.

According to certain embodiments, the communication interface module 150 may be connected with the electronic device 200 using the local area communication technology. The local area communication technology according to this embodiment may include a Bluetooth, a Radio Frequency Identification (RFID), an infrared Data Association (IrDA), an Ultra Wideband (UWB), ZigBee, WFD (Wi-Fi Direct), a Near Field Communication (NFC), and so on.

According to certain embodiments, the communication interface module 150 may transmit and receive data through a wire or wireless network or through wire serial communications. At this time, the network may include, but is not limited to, an Internet, a Local Area Network (LAN), Wireless LAN (Wireless Local Area Network), a Wide Area Network (WAN), a Personal Area Network (PAN), and so on. It will be apparent to one skilled in the art that the network is any other type of network capable of transmitting and receiving information.

The electronic device 200 may be connected to the hearing aid 100. The electronic device 200 may fit the hearing aid 100 using the hearing aid program. The electronic device 200 may set attention words to the hearing aid 100 through the hearing aid program.

Also, the electronic device 200 may receive an attention word related to a dangerous situation from the hearing aid 100. The electronic device 200 may notify a user of a relevant dangerous situation by displaying the dangerous situation or generating (or outputting) vibration or sound.

In various embodiments, the hearing aid 100 may include a storage unit 110 configured to store designated attention word data, a sound detecting module 120 configured to acquire a sound signal, a control module 130 configured to compare at least a portion of the sound signal with the designated attention word data and to modulate at least a portion of the sound signal when at least a portion of the sound signal is determined as being similar to the designated attention word data; and a sound outputting module 140 configured to output the sound signal thus modulated.

In various embodiments, the attention word data may be a combination of at least one voice acoustic waveforms constituting an attention word.

In various embodiments, the control module 130 may adjust the sound signal by applying at least one of an increase in an output level or a shift of a frequency band to the sound signal.

In various embodiments, the control module 130 may set the attention word through a hearing aid program of an electronic device 200 functionally connected with the hearing aid 100.

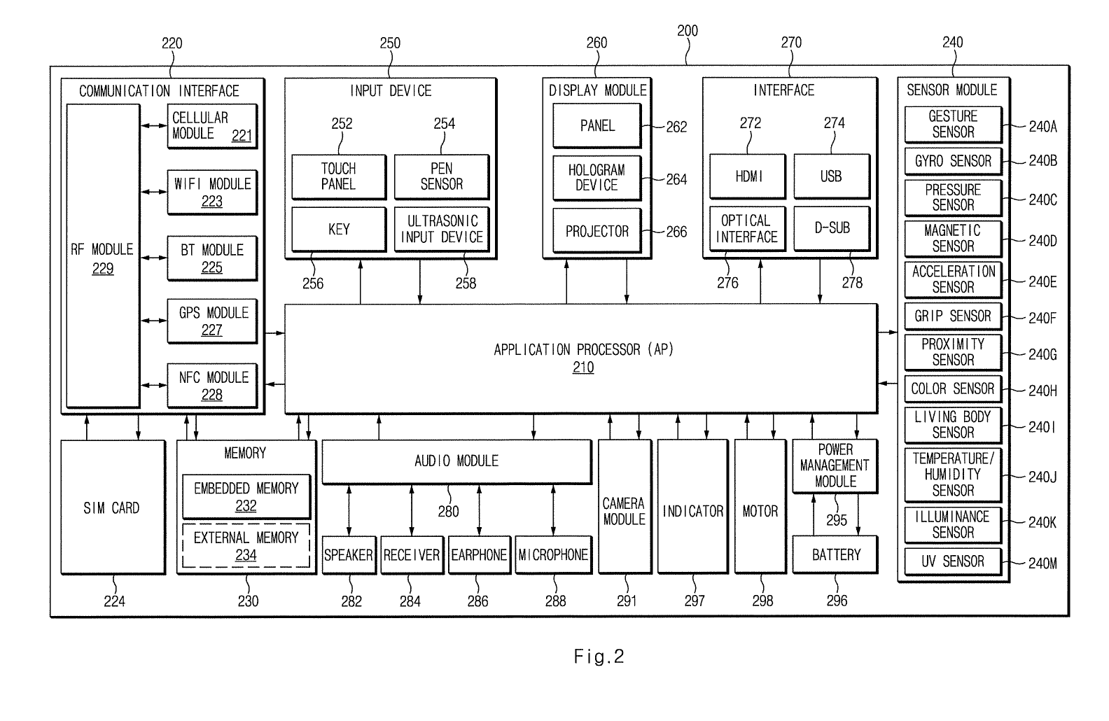

FIG. 2 illustrates a block diagram of an electronic device according to various embodiments of the present disclosure. Referring to FIG. 2, an electronic device 200 may include at least one of one or more Application Processors (AP) 210, a communication module 220, a SIM (Subscriber Identification Module) card 224, a memory 230, a sensor module 240, an input module 250, a display module 260, an interface 270, an audio module 280, a camera module 291, a power management module 295, a battery 296, an indicator 297, or a motor 298.

The AP 210 may drive operating systems or application programs to control a plurality of hardware and software components connected to the AP 210 and may process and compute a variety of data including multimedia data.

The AP 210 may fit a hearing aid 100 through a hearing aid program. Furthermore, the AP 210 may set attention words to the hearing aid 100 based on attention word database.

The AP 210 may also extract attention words from a contact list, a call list, call listening contents, and so on of a user using an application (hereinafter referred to as “call app”) related to telephone conversion.

The AP 210 may be implemented with System on Chip (SoC). According to an embodiment of the present disclosure, the AP 210 may further include a Graphics Processing Unit (GPU).

The communication module 220 may perform data transmission and reception in communication between other electronic devices connected with the electronic device 200 through a network. For example, the other electronic devices may include the hearing aid 100, a sever 300, and so on.

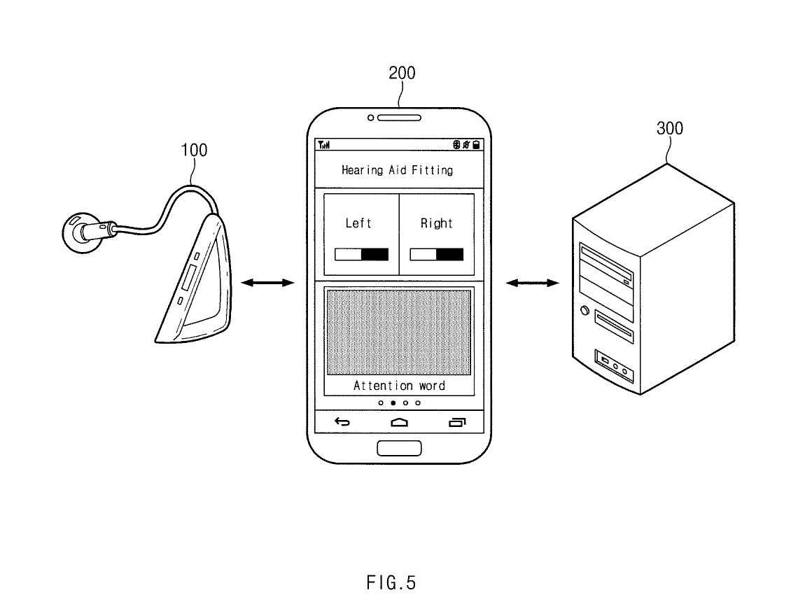

The communication module 220 may search for the hearing aid 100 and may connect therewith. The communication module 220 may communicate with the hearing aid 100 connected with the electronic device 200. The electronic device 200 may set attention words, included in the attention word database of the memory 230, to the hearing aid 100 through the communication module 220. Alternatively, the communication module 220 may receive an attention word associated with a dangerous situation, detected by the hearing aid 100, from the hearing aid 100. The communication module 220 may receive an attention word or an attention word list from the server device 300 (shown in FIG. 5) or may send an attention word or an attention word list, which a user writes up, to the server device 300.

According to an embodiment, the communication module 220 may include a cellular module 221, a Wi-Fi module 223, a BT (BlueTooth) module 225, a GPS (Global Positioning System) module 227, an NFC (Near Field Communication) module 228, and an RF (Radio Frequency) module 229.

The cellular module 221 may provide a voice call, a video call, a text messaging service, or an interne service through a communications network (e.g., LTE, LTE-A, CDMA, WCDMA, UMTS, WiBro, or GSM, etc.). The cellular module 221, for example, may perform discrimination and certification of an electronic device within the communications network using a subscriber identification module (e.g., a SIM card 224). According to an embodiment, the cellular module 221 may perform at least a portion of functions that the AP 210 provides. For example, the cellular module 221 may perform at least a portion of a multimedia control function.

According to an embodiment, the cellular module 221 may include a Communication Processor (CP). Also, the cellular module 221 may be implemented with, for example, a SoC. Though components such as the cellular module 221 (e.g., a CP), the memory 230, or the power management module 295 are illustrated as being components independent of the AP 210 in FIG. 2, the AP 210 according to an embodiment of the present disclosure may be implemented to include at least a portion (e.g., a cellular module 221) of the above components.

According to an embodiment, the AP 210 or the cellular module 221 (e.g., a communication processor) may load and process an instruction or data received from nonvolatile memories respectively connected thereto or from at least one of other elements at a volatile memory. Also, the AP 210 or the cellular module 221 may store data received from at least one of other elements or generated by at least one of other elements at a nonvolatile memory.

Each of the Wi-Fi module 223, the BT module 225, the GPS module 227, and the NFC module 228 may include a processor for processing data exchanged through a relevant module, for example. In FIG. 2, an embodiment of the inventive concept is exemplified as the cellular module 221, the Wi-Fi module 223, the BT module 225, the GPS module 227, and the NFC module 228 are discrete blocks, respectively. According to an embodiment, at least a portion (e.g., two or more components) of the cellular module 221, the Wi-Fi module 223, the BT module 225, the GPS module 227, and the NFC module 228 may be included within one Integrated Circuit (IC) or an IC package. For example, at least a portion (e.g., a communication processor corresponding to the cellular module 221 and a Wi-Fi processor corresponding to the Wi-Fi module 223) of communication processors corresponding to the cellular module 221, the Wi-Fi module 223, the BT module 225, the GPS module 227, and the NFC module 228 may be implemented with one SoC.

The RF module 229 may transmit and receive data, for example, a RF signal. Though not shown, the RF module 229 may include a transceiver, a Power Amplifier Module (PAM), a frequency filter, or Low Noise Amplifier (LNA), etc. Also, the RF module 229 may further include the following part for transmitting and receiving an electromagnetic wave in a space in wireless communication: a conductor or a conducting wire. In FIG. 2, an embodiment of the inventive concept is exemplified as the cellular module 221, the Wi-Fi module 223, the BT module 225, the GPS module 227, and the NFC module 228 are implemented to share one RF module 229. According to an embodiment, at least one of the cellular module 221, the Wi-Fi module 223, the BT module 225, the GPS module 227, or the NFC module 228 may transmit and receive an RF signal through a separate RF module.

The SIM card 224 may be a card that includes a subscriber identification module and may be inserted into a slot formed at a specific position of the electronic device. The SIM card 224 may include unique identification information (e.g., Integrated Circuit Card Identifier (ICCID)) or subscriber information (e.g., Integrated Mobile Subscriber Identify (IMSI)).

The memory 230 may store an attention word database. Thus, the electronic device 200 may send attention words to the hearing aid 100 based on the attention word database stored at the electronic device 200.

The attention word database may include attention words requiring user's attention and attention word data corresponding thereto. At this time, the attention word may include a word related to a dangerous situation or a user name, etc.

The attention word database may be basically provided together with the hearing aid program. For example, common attention words of all users such as basic words related to safety of a user or words requiring attention in daily life may be previously provided to the hearing aid 100 or to the attention word database of the hearing aid program.

Words that a user believes to be an attention word may be individually added to the attention word database. For example, upon fitting the hearing aid 100, attention words may be inputted through user's request or directly by the user through the input module 250. At this time, attention word data of the input attention word may be received from the server device 300 or may be generated directly by the electronic device 200.

According to certain embodiments, the electronic device 200 may receive an attention word list from the server device 300 and may update the attention word database with the attention word list.

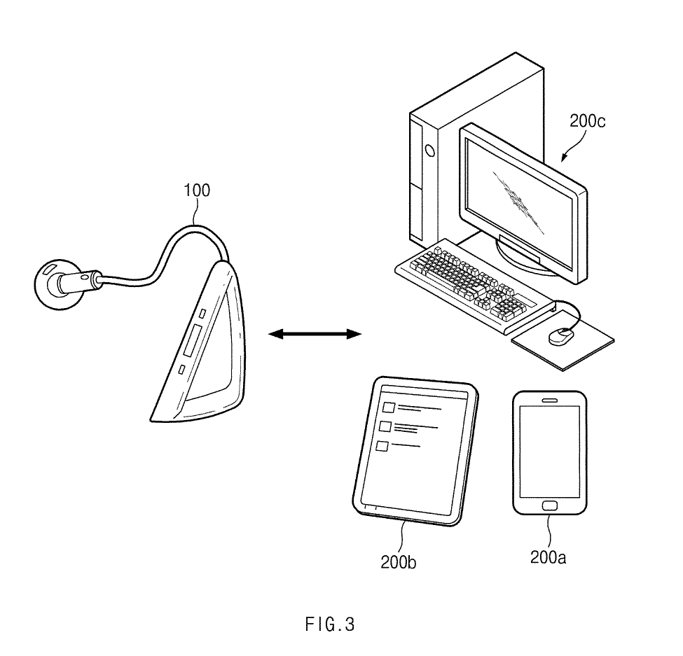

According to another embodiment, the electronic device 200 may directly extract attention words using personal information of a user and may add the extract words to the attention word database. For example, in the event that the electronic device 200 is a mobile terminal, the electronic device 200 may extract attention words from a contact list, a call list, and call listening contents, and so on using the call app of the mobile terminal. This will be more fully described with reference to FIG. 3. The electronic device 200 may automatically add the extracted words to the attention word database or may add attention words, selected by a user, from among the extracted attention words to the attention word database. At this time, attention word data of the extracted attention word may be received from the server device 300 or may be generated directly by the electronic device 200.

The memory 230 may include an embedded memory 232 or an external memory 234. For example, the embedded memory 232 may include at least one of a volatile memory (for example, a Dynamic RAM (DRAM), a Static RAM (SRAM), a Synchronous Dynamic RAM (SDRAM), etc.), or a nonvolatile memory (e.g., an One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, etc.).

According to various embodiments, the embedded memory 232 may be a Solid State Drive (SSD). The external memory 234 may further include a flash drive, for example, a Compact Flash (CF), a Secure Digital (SD), a Micro-Secure Digital (SD), a mini-SD, an extreme Digital (xD), or a memory stick, etc. The external memory 234 may be functionally connected with the electronic device 200 through various interfaces. According to an embodiment, the electronic device 200 may further include storage (or a storage medium) such as a hard disk drive.

The sensor module 240 may measure a physical quantity or may detect an operation state of the electronic device 200. The sensor module 240 may convert the measured or detected information to an electric signal. The sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., an RGB sensor), a living body sensor 240I, a temperature/humidity sensor 240J, an illuminance sensor 240K, or an ultraviolet (UV) sensor 240M. Additionally or generally, though not shown, the sensor module 240 may further include an E-nose sensor, an ElectroMyoGraphy sensor (EMG) sensor, an ElectroEncephaloGram (EEG) sensor, an ElectroCardioGram (ECG) sensor, a photoplethysmography (PPG) sensor, an InfraRed (IR) sensor, an iris sensor, or a fingerprint sensor, for example. The sensor module 240 may further include a control circuit for controlling at least one or more sensors included therein.

The input module 250 may receive an attention word(s) from a user. Furthermore, the input module 250 may receive selection information indicating whether to register an attention word extracted from the user at the attention word database.

The input module 250 may include a touch panel 252, a (digital) pen sensor 254, a key 256, or an ultrasonic input module 258. The touch panel 252 may recognize a touch input using at least one of a capacitive type, a resistive type, an infrared type, or an ultrasonic wave type. Also, the touch panel 252 may further include a control circuit. In case of the capacitive type, a physical contact or proximity recognition is possible. The touch panel 252 may further include a tactile layer. In this case, the touch panel 252 may provide a tactile reaction to a user.

The (digital) pen sensor 254 may be implemented, for example, using a method, which is the same as or similar to receiving a user touch input, or using a separate sheet for recognition. The key 256, for example, may include a physical button, an optical key, or a keypad. The ultrasonic input module 258 may be a device, which allows the electronic device 200 to detect a sound wave using a microphone (e.g., a microphone 288) and to determine data through an input tool generating an ultrasonic signal, and makes wireless recognition possible. According to an embodiment, the electronic device 200 may receive a user input from an external module (e.g., a computer or a server device) connected thereto using the communication module 220.

The display module 260 may display an input attention word, an attention word received from the server device 300, or an attention word extracted by the processor 230 on a screen. Furthermore, when receiving an attention word related to a dangerous situation from the hearing aid 100, the display module 260 may display a relevant dangerous situation on a screen to notify a user of the dangerous situation.

The display module 260 may include a display driving module 262, a panel 262, a hologram device 264, or a projector 266. According to an embodiment, the display driving module 262 may further include a control circuit for controlling the panel 262, the hologram device 264, or the projector 266. The panel 262 may be a liquid-crystal display (LCD) or an active-matrix organic light-emitting diode (AMOLED). The panel 262, for example, may be implemented to be flexible, transparent, or wearable. The panel 262 and the touch panel 252 may be implemented with one module. The hologram device 264 may show a three-dimensional image in a space using interference of light. The projector 266 may project light onto a screen to display an image. The screen, for example, may be positioned in the inside or outside of the electronic device 200.

The interface 270, for example, may include an HDMI (high-definition multimedia interface) 272, a USB (universal serial bus) 274, an optical interface 276, or a D-sub (D-subminiature) 278. Additionally or generally, the interface 270, for example, may include a Mobile High Definition Link (MHL) interface, a SD card/Multi-media cared (MMC) interface, or an Infrared Data Association (IrDA) standard interface.

When receiving an attention word related to a dangerous situation from the hearing aid 100, the audio module 280 may output a sound corresponding to the dangerous situation to inform a user of the dangerous situation. The audio module 280, for example, may process sound information that is input or output through a speaker 282, a receiver 284, an earphone 286, or a microphone 288.

The camera module 291 may be a module that shoots a still picture and a moving picture. According to an embodiment, the camera module 291 may include one or more image sensors (e.g., a front sensor or a rear sensor), a lens (not shown), an Image Signal Processor (ISP) (not shown), or a flash (not shown) (e.g., an LED or a xenon lamp).

The power management module 290 may manage the power of the electronic device 200. The power management module 290 may include a Power Management Integrated Circuit (PMIC), a Charger Integrated Circuit (IC), or a battery or fuel gauge.

The PMIC, for example, may be embedded in an IC or a SoC semiconductor. A charging method may be classified as a wired method or a wireless method. The charger IC may charge a battery and may prevent an overvoltage or an overcurrent from being input from a charger. According to an embodiment, the charger IC may include a charger IC for at least one of a wired charging method and a wireless charging method. The wireless charging method, for example, may be a magnetic resonance method, a magnetic induction method, or an electromagnetic method. An additional circuit for wireless charging, for example, circuits such as a coil loop, a resonance circuit, or a rectifier may be further provided.

A battery gauge, for example, may measure a remnant of the battery 296 or a voltage, a current, or a temperature of the battery 296 during charging. The battery 296 may store or generate electricity and may supply power to the electronic device 200 using the stored or generated electricity. The battery 296, for example, may include a rechargeable battery or a solar battery.

The indicator 297 may display the following specific state of the electronic device 200 or a portion (e.g., the AP 210) thereof: a booting state, a message state, or a charging state. The indicator 297 may include an LED.

The motor 298 may convert an electric signal to mechanical vibration. Also, when an attention word related to a dangerous situation is received from the hearing aid 100, the motor 298 may inform a user of the dangerous situation.

Though not shown, the electronic device 200 may include a processing module (e.g., a GPU) for supporting a mobile TV. The processing module for supporting the mobile TV, for example, may process media data that is based on the standard of Digital Multimedia Broadcasting (DMB), Digital Video Broadcasting (DVB), or media flow.

The server device 300 may provide a user of the hearing aid 100 with an attention word list that is generated based on attention words fed back from users. The server device 300 may provide an attention word list that is continuously updated. The electronic device 200 may be provided with the attention word list from the server device 300 periodically or randomly and may update the attention word database based on the attention word list.

According to various embodiments, the electronic device 200 may include a storage unit (e.g., a memory 230) configured to store attention word database; a communication interface module (e.g., a communication module 220) configured to communicate with the electronic device 200 functionally; and a processor (e.g., an AP 210) configured to set an attention word of the attention word database to the hearing aid 100 using a hearing aid program.

According to various embodiments, the electronic device 200 may further include an input/output interface module (e.g., an input module 250) configured to receive an attention word from a user. The input/output interface module may receive an attention word from a server device, and the storage unit may store at least one of an attention word received through the input/output interface module or an attention word received from the server device and the input attention word or attention word data on an attention word received from the server device, at the attention word database.

According to various embodiments, the electronic device 200 may be a mobile terminal. The processor may extract an attention word from at least one of a contact list, a call list, or call listening contents of a user, and the storage unit may store the extracted attention word and attention word data on the extracted attention word at the attention word database.

According to various embodiments, the electronic device 200 may further include an input/output interface module (e.g., a display module 260), an audio module 280, and a motor 298. When a sound signal corresponds to an attention word related to a dangerous situation, the input/output interface module may notify a user of the dangerous situation using an indication on a screen, a visual indication other than a screen, an output of vibration, or an output of sound.

FIG. 3 illustrates an environment for setting an attention word to a hearing aid, according to various embodiments.

An electronic device 200 according to this embodiment may be connected with a hearing aid 100 and may fit the hearing aid 100. The electronic devices 200a-200c, as illustrated in FIG. 3, may set an attention word(s) of the hearing aid 100 through a hearing aid program. For example, the hearing aid program may be fitting software.

The fitting software may make it possible to set a parameter suitable for a hearing characteristic of a hearing aid user to the hearing aid 100. For example, for a user whose hearing decreases at a high frequency band, the hearing aid 100 may be set through the fitting software to have a high amplification gain at a relevant frequency band. In this embodiment, the fitting software may be exemplified. However, the scope and spirit of the present disclosure may not be limited thereto. For example, this embodiment may include all hearing aid related programs capable of changing setting of the hearing aid 100.

The electronic device 200 (for example, 200a, 200b, 200c) may receive an attention word from a user to update attention word database stored at the electronic device 200. The electronic device 200 may set an attention word of the updated attention word database to the hearing aid 100 through the hearing aid program.

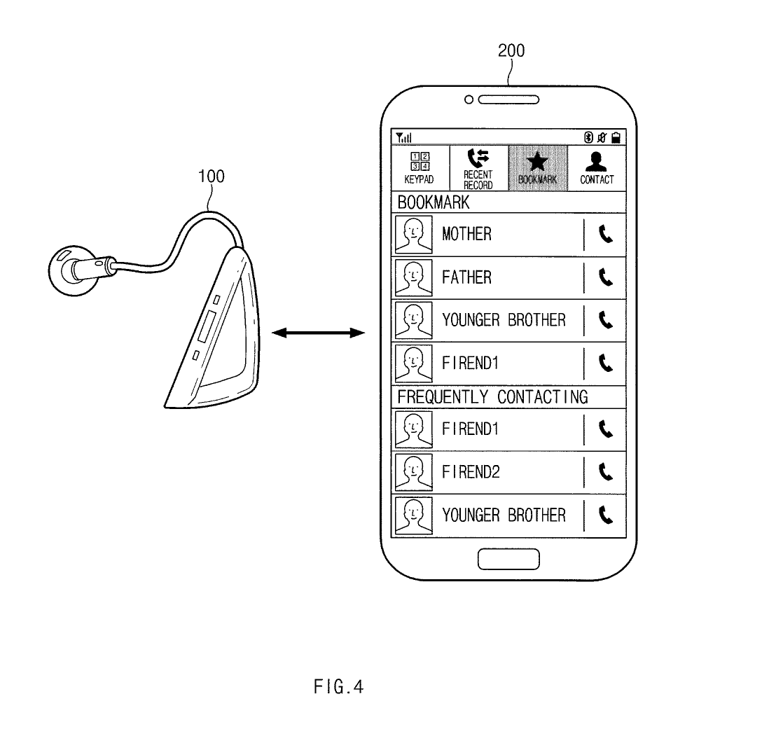

Alternatively, the electronic device 200 may update the attention word database with an attention word(s) that the electronic device 200 automatically extracts. This will be more fully described with reference to FIG. 4.

FIG. 4 illustrates an environment for setting an attention word to a hearing aid, according to various embodiments.

An electronic device 200 according to this embodiment may extract attention words from a contact list, a call list, and call listening contents of a user through a call app.

The call app may extract an attention word from the contact list of the user. For example, the electronic device 200 may extract family member names registered at the contact list and may add the extracted family member names as attention words. In this case, the electronic device 200 may automatically add the extracted family member names to the attention word database. Alternatively, a user may select whether to add the extracted family member names to the attention word database, and only a selected word(s) may be added to the attention word database.

The call app may extract an attention word from a bookmark list of the call list. The electronic device 200 may extract a bookmarked name and may add the extracted name as an attention word. Referring to a screen shown in FIG. 4, the electronic device 200 may bring (or extract) “mother”, “father”, “younger brother”, “friend 1”, etc. in the bookmark list as attention words. The electronic device 200 may automatically add the extracted names to the attention word database. Alternatively, a user may select whether to add the extracted names to the attention word database, and only a selected word(s) may be added to the attention word database.

Alternatively, the call app may extract an attention word(s) from a list of persons of the call list to which a user frequently calls. The electronic device 200 may extract a name of a person marked as frequently calling and may add the extracted name as an attention word. Referring to a screen shown in FIG. 4, the electronic device 200 may extract names corresponding to “friend 1”, “friend 2”, and “younger brother” as names marked as frequently calling. As described above, the electronic device 200 may automatically add the extracted names to the attention word database. Alternatively, a user may select whether to add the extracted names to the attention word database, and only a selected word(s) may be added to the attention word database.

The call app may extract a word, the number of uses of which is over a predetermined number, from among call listening contents. In this case, the electronic device 200 may extract a word(s) as a word(s) that a user frequently uses during calling and may automatically add the extracted names to the attention word database. Alternatively, a user may select whether to add the extracted word(s) to the attention word database, and only a selected word(s) may be added to the attention word database.

Besides, the electronic device 200 may extract an attention word(s) using personal information of a user and may add the extracted word(s) to the attention word database.

As described above, the electronic device 200 may add an attention word(s) to the attention word database and may set an attention word(s) stored at the attention word database to the hearing aid 100 through a hearing aid program.

FIG. 5 illustrates an environment for setting an attention word to a hearing aid, according to various embodiments.

An electronic device 200 according to this embodiment may set an attention word received through a server device 300 to a hearing aid 100.

When receiving an attention word list and attention word data corresponding thereto, the electronic device 200 may update attention word database stored therein. The electronic device 200 may set an attention word to the hearing aid 100 based on the updated attention word database.

At this time, the server device 300 may provide the attention word list to users and may receive attention words fed back from the users. The server device 300 may continue to update the attention word list based on the attention words fed back from the users. The attention word list may be provided to the electronic device 200 from the server device 300 periodically or randomly.

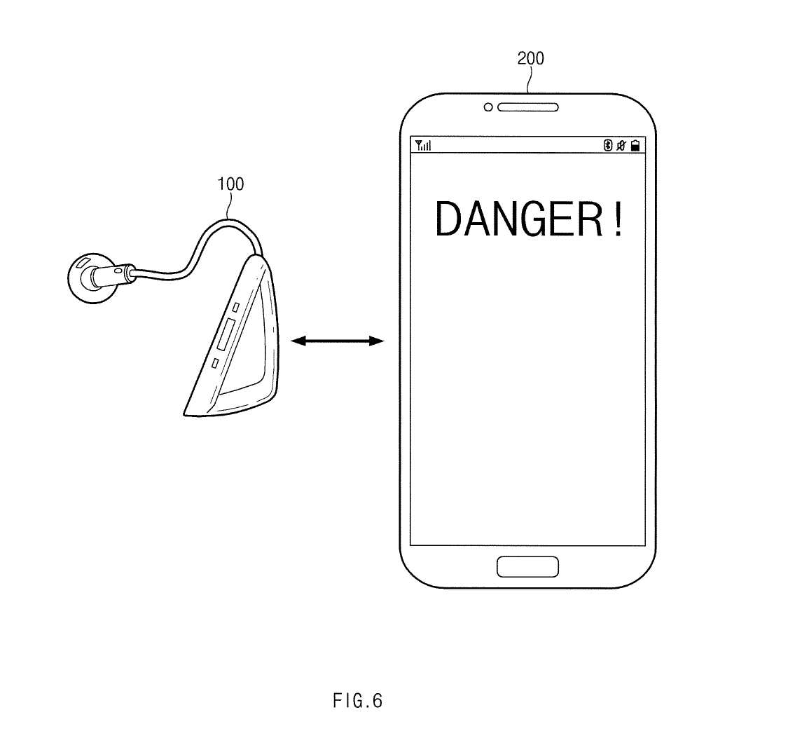

FIG. 6 illustrates a screen for notifying a danger at an electronic device operating in conjunction with a hearing aid, according to various embodiments.

An electronic device 200 according to this embodiment may notify a user of a dangerous situation in conjunction with a hearing aid 100.

If the hearing aid 100 determines that a sound signal corresponding to an attention word related to a dangerous situation is input, it may send the attention word related to the dangerous situation to the electronic device 200 functionally connected with the hearing aid 100.

The electronic device 200 may receive an attention word related to a dangerous situation from the hearing aid 100 and may display a relevant dangerous situation to a user through a display device in the form of multimedia data or text data, etc. For example, the electronic device 200 may notify a danger to a user as illustrated in FIG. 6. Alternatively, the electronic device 200 may display an attention word related to a dangerous situation from the hearing aid 100 on a screen. For example, the electronic device 200 may display an attention word such as “danger”, “avoid!”, “careful!”, “fire!” etc.

The electronic device 200 may output vibration or sound to inform a user of a dangerous situation. For example, the electronic device 200 may output an attention word related to a dangerous situation through a speaker. In this case, the electronic device 200 may output an attention word related to a dangerous situation by sound louder than sound output from the hearing aid 100. Alternatively, the electronic device 200 may output vibration, thereby allowing a user to perceive a dangerous situation.

The electronic device 200 may use two or more of an output of sound, an output of vibration, and an indication on a screen such that a user perceives a dangerous situation well. For example, after outputting vibration to turn user's attention to the electronic device 200, the electronic device 200 may display an attention word related to a dangerous situation on a screen such that the user recognizes the dangerous situation.

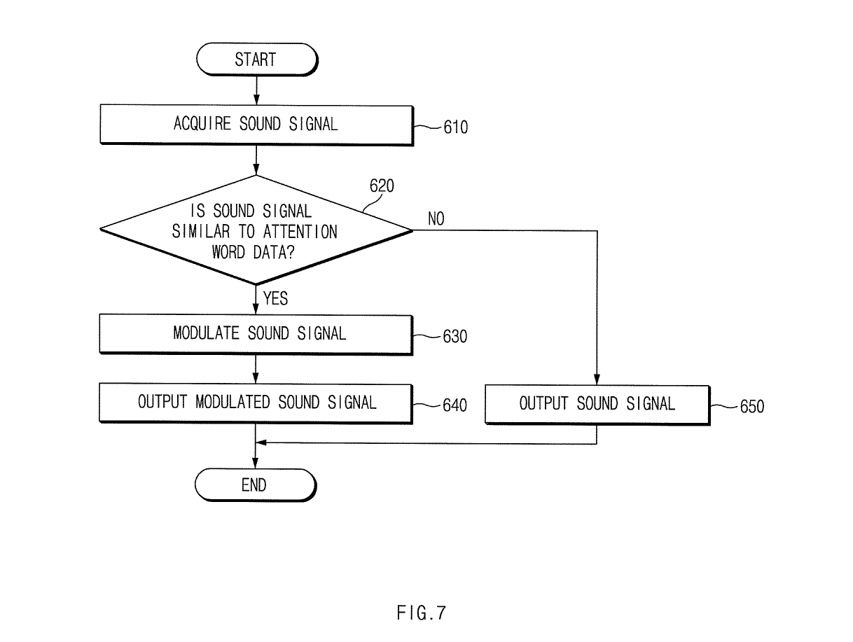

FIG. 7 illustrates a method for modulating sound of a hearing aid, according to various embodiments. A flowchart shown in FIG. 7 may include steps that a hearing aid 100 shown in FIGS. 1 to 6 processes time-sequentially. Thus, even though contents are omitted below, contents about an electronic device 200 described with reference to FIGS. 1 to 6 may be applied to a flowchart shown in FIG. 7.

In operation 610, a sound detecting module 120 may acquire a sound signal.

In operation 620, a control module 130 may compare the sound signal with attention word data to determine whether at least a portion of the sound signal is similar to the attention word data. According to certain embodiments, the control module 130 may compare the sound signal and attention word data to determine correspondence between the sound signal and the attention word data.

If the sound signal corresponds to the attention word data of an attention word, the method proceeds to operation 630. If the sound signal does not correspond to the attention word data of an attention word, the method proceeds to operation 650.

In operation 630, the control module 130 may modulate the sound signal corresponding to the attention word. For example, to modulate the sound signal, the control module 130 may increase an output level of the sound signal corresponding to the attention word or may shift a frequency band of sound signal corresponding to the attention word. Alternatively, the control module 130 may modulate the sound signal through both a change in the output level of the sound signal corresponding to the attention word and a shift of a frequency band thereof.

In operation 640, the sound outputting module 140 may output the modulated sound signal, thereby allowing a user of the hearing aid 100 to recognize an attention word better than other sound.

According to an embodiment, the control module 130 may further compare the sound signal with attention word data that is stored at the hearing aid 100 and corresponds to sound related to a dangerous situation. When the sound signal corresponds to sound related to a dangerous situation, the control module 130 may modulate and output the sound signal corresponding to sound related to a dangerous situation.

According to various embodiments, a method for modulating sound at a hearing aid may include acquiring a sound signal at the hearing aid; comparing at least a portion of the sound signal with designated attention word data; modulating the at least a portion of the sound signal when the comparison result indicates that the at least a portion of the sound signal is similar to the designated attention word data; and outputting the modulated sound signal.

According to various embodiments, the attention word data may be a combination of at least one voice acoustic waveforms constituting the attention word.

According to various embodiments, the modulating may include applying at least one of an increase in an output level or a shift of a frequency band to the sound signal.

According to various embodiments, the modulating may include shifting a frequency band of the sound signal into an optimum frequency band.

According to various embodiments, the optimum frequency band may be determined according to a hearing characteristic of a user of the hearing aid.

According to various embodiments, the comparing may include comparing the sound signal with the attention word data by the frame, calculating a score based on correspondence between the sound signal and the attention word data determined by the frame; and determining the sound signal as corresponding to the attention word, when the calculated score is greater than or equal to a reference score.

According to various embodiments, the method for modulating may further include setting the attention word to the hearing aid through a hearing aid program of an electronic device functionally connected with the hearing aid.

According to various embodiments, the electronic device may set the attention word to the hearing aid based on attention word database stored therein, and the attention word database may include at least one of an attention word that a user inputs to the electronic device or an attention word that the electronic device receives from a server device and attention word data corresponding to the at least one attention word.

According to various embodiments, the electronic device may be a mobile terminal. The mobile terminal may set the attention word to the hearing aid based on attention word database stored therein. The attention word database may include at least one of attention words which the mobile terminal extracts from at least one of a contact list, a call list or call listening contents of a user, an attention word, selected by the user, from among the extracted attention words, or attention word data on the attention word or an attention word selected by the user.

According to various embodiments, the extracted attention word may include at least one of family member names registered at the contact list, a bookmarked name of the call list, a name of the call list corresponding to a person marked as frequently calling, or a word, used over a predetermined number, from among the call listening contents.

According to various embodiments, a method for modulating sound at a hearing aid may include outputting an indication on a screen of an electronic device associated with guidance of the dangerous situation or at least one of a visual indication other than the screen, vibration, or sound at the electronic device connected with the hearing aid, when the sound signal corresponds to an attention word related to the dangerous situation.

Each of the above components of the electronic device according to an embodiment of the present disclosure may be implemented using one or more components, and a name of a relevant component may vary based on the kind of the electronic device. The electronic device according to various embodiments of the present disclosure may include at least one of the above components. Also, a portion of the components may be omitted, or additional other components may be further included. Also, some of the components of the electronic device according to the present disclosure may be combined to form one entity, thereby making it possible to perform the functions of the relevant components substantially the same as before the combination.

The term “module” used for the present disclosure, for example, may mean a module including one of hardware, software, and firmware or a combination of two or more thereof. A “module”, for example, may be interchangeably used with terminologies such as a module, logic, a logical block, a component, a circuit, etc. The “module” may be a minimum module of a component integrally configured or a portion thereof. The “module” may be a minimum module performing one or more functions or a portion thereof. The “module” may be implemented mechanically or electronically. For example, the “module” according to the present disclosure may include at least one of an Application-Specific Integrated Circuit (ASIC) chip performing certain operations, a Field-Programmable Gate Arrays (FPGAs), or a programmable-logic device, known or to be developed in the future.

According to an embodiment, at least a portion of an apparatus (e.g., modules or functions) or a method (e.g., operations) according to the present disclosure, for example, may be implemented by instructions stored in a computer-readable storage media in the form of a programmable module. The instruction, when executed by one or more processors (e.g., a processor 620), may perform a function corresponding to the instruction. The computer-readable storage media, for example, may be a memory 630. At least a portion of the programming module, for example, may be implemented (e.g., executed) by the processor 620. At least a portion of the programming module may include the following for performing one or more functions: a module, a program, a routine, a set of instructions, or a process.

A computer-readable storage media may include a hard disk, a magnetic media such as a floppy disk and a magnetic tape, an optical media such as Compact Disc Read Only Memory (CD-ROM) and a Digital Versatile Disc (DVD), a magneto-optical media such as a floptical disk, and the following hardware devices specifically configured to store and perform a program instruction (e.g., a programming module): Read Only Memory (ROM), Random Access Memory (RAM), and a flash memory. Also, a program instruction may include not only a mechanical code such as things generated by a compiler but also a high-level language code executable on a computer using an interpreter. The above hardware module may be configured to operate via one or more software modules for performing an operation of the present disclosure, and vice versa.

A module or a programming module according to an embodiment of the present disclosure may include at least one of the above elements, a portion of the above elements may be omitted, or additional other elements may be further included. Operations performed by a module, a programming module, or other elements according to an embodiment of the present disclosure may be executed sequentially, in parallel, repeatedly, or in a heuristic method. Also, a portion of operations may be executed in different sequences, omitted, or other operations may be added.

Although the present disclosure has been described with embodiments, various changes and modifications may be suggested to one skilled in the art. It is intended that the present disclosure encompass such changes and modifications as fall within the scope of the appended claims.

What is claimed is:

1. A method for modulating sound at a hearing aid comprising:
acquiring a sound signal at the hearing aid;
modulating the at least a portion of the sound signal when the at least a portion of the sound signal is similar to a designated attention word data; and
outputting the modulated sound signal.

2. The method of claim 1, wherein the attention word data is a combination of at least one voice acoustic waveform constituting an attention word.

3. The method of claim 1, wherein the modulating comprises:
applying at least one of an increase in an output level and a shift of a frequency band to the sound signal.

4. The method of claim 3, wherein the modulating comprises:
shifting a frequency band of the sound signal into an optimum frequency band.

5. The method of claim 4, wherein the optimum frequency band is determined according to a hearing characteristic of a user of the hearing aid.

6. The method of claim 1, further comprising:
comparing the sound signal with the attention word data by a frame;
calculating a score based on correspondence between the sound signal and the attention word data determined by the frame; and
determining the sound signal as corresponding to the attention word, when the calculated score is greater than or equal to a reference score.

7. The method of claim 1, further comprising:
setting the attention word to the hearing aid through a hearing aid program of an electronic device functionally connected with the hearing aid.

8. The method of claim 7, wherein the electronic device sets the attention word to the hearing aid based on an attention word database stored in the electronic device, and wherein the attention word database comprises at least one of:
an attention word that a user inputs to the electronic device,
an attention word that the electronic device receives from a server device and attention word data corresponding to the input attention word, or
the attention word received from the server device.

9. The method of claim 7, wherein the electronic device is a mobile terminal,
wherein the mobile terminal sets the attention word to the hearing aid based on an attention word database stored in the mobile terminal, and
wherein the attention word database comprises at least one of:
attention words the mobile terminal extracts from at least one of:
a contact list,
a call list,
call listening contents of a user,
an attention word, selected by the user, from among the extracted attention words, attention word data on the attention word, or
an attention word selected by the user.

10. The method of claim 9, wherein the extracted attention word comprises at least one of family member names registered at the contact list, a bookmarked name of the call list, a name of the call list corresponding to a person marked as frequently calling, and a word from among the call listening contents that is used more than a predetermined number of repetitions.

11. The method of claim 1, further comprising:
when the sound signal corresponds to an attention word related to the dangerous situation, outputting at least one of:
an indication on a screen of an electronic device associated with guidance of the dangerous situation,
at least one of a visual indication other than on the screen,
a vibration, or
sound from the electronic device connected with the hearing aid.

12. A non-transitory computer-readable medium embodying a program comprising computer readable program code that, when executed by processing circuitry, causes the processing circuitry to:
acquire a sound signal at a hearing aid;
modulate at least a portion of the sound signal when the at least a portion of the sound signal is similar to a designated attention word data; and
output the modulated sound signal.

13. A hearing aid comprising:
a storage configured to store designated attention word data;
a sound detecting module configured to acquire a sound signal;
a control module configured to modulate at least a portion of the sound signal if the at least a portion of the sound signal is similar to the designated attention word data; and
a sound outputting module configured to output the modulated sound signal.

14. The hearing aid of claim 13, wherein the attention word data includes a combination of at least one voice acoustic waveforms constituting the attention word.

15. The hearing aid of claim 13, wherein the control module is configured to apply at least one of an increase in an output level and a shift of a frequency band to the sound signal to modulate the sound signal.

16. The hearing aid of claim 13, wherein the control module is configured to set an attention word through a hearing aid program of an electronic device functionally connected with the hearing aid.

17. An electronic device comprising:
a storage configured to store attention word database;
a communication interface module configured to communicate with a hearing aid functionally connected with the electronic device; and
a processor configured to set an attention word of the attention word database to the hearing aid using a hearing aid program.

18. The electronic device of claim 17, further comprising:
an input/output interface module configured to receive an attention word from a user, and wherein the input/output interface module is configured to receive an attention word from a server device, and
wherein the storage is configured to store, at the attention word database, at least one of:
an attention word received through the input/output interface module,
an attention word received from the server device and attention word data on the input attention word, or
an attention word received from the server device.

19. The electronic device of claim 17, wherein the electronic device is a mobile terminal,
wherein the processor is configured to extract an attention word from at least one of a contact list, a call list, and call listening contents of a user, and
wherein the storage is configured to store the attention word database including the extracted attention word and attention word data on the extracted attention word.

20. The electronic device of claim 17, further comprising an input/output interface module configured to
when a sound signal corresponds to an attention word related to a dangerous situation, notify a user of the dangerous situation using at least one of: an indication on a screen, a visual indication other than on the screen, an output of vibration, or an output of sound.
